(19) United States
(12) Patent Application Publication
(10) Pub. No.: US 2008/0135656 A1
(43) Pub. Date: Jun. 12, 2008

(54) Tub Grinder with Built-In Colorant System

(76) Inventors: Jeff D. Bradley, Pella, IA (US); Duane R. DeBoef, Sherrard, IL (US); Harris A. Steenhoek, Pella, IA (US)

Correspondence Address: STURM & FIX LLP, 206 SIXTH AVENUE, SUITE 1213, DES MOINES, IA, 50309-4076, US

(21) Appl. No.: 11/567,913

(22) Filed: Dec. 7, 2006

(51) Int. Cl. B02C 23/18

(52) U.S. Cl. 241/101.6

(57) ABSTRACT

An apparatus for grinding and concurrently applying coating materials to manufacture a coated product includes a substantially cylindrical tub for receiving material to be ground. The tub is attached for rotation for causing material to be funneled towards an aperture in a bottom operatively rigidly attached to the frame. The bottom is disposed below the tub for forming a container with the tub. At least one curved screen is operatively attached to the frame below the aperture in the bottom. The curved screen is disposed about an axis of curvature and the curved screen has openings therein. A cylindrical grinding drum is attached in a rotational relationship to the frame about a drum axis that is coincident with the axis of curvature of the curved screen. The cylindrical drum has an exterior periphery of the drum with teeth operatively attached to the exterior periphery of the drum. The teeth are adjacent to the curved screen whereby when the drum rotates material is ground between the screen and exterior periphery of the drum by the teeth. This arrangement forces material between the exterior of the drum and the curved screen to be ground into pieces that are small enough to pass through the openings in the screen. Thus a material fragmentation zone is formed below the aperture in the bottom of the tub, above curved screen and between the exterior periphery of the grinding drum and the curved screen. A material deflector is operatively rigidly attached to the floor and is disposed over a portion of the aperture in the bottom of the tub thereby separating the material fragmentation zone from the material above the floor. A coating injection apparatus provided above the material deflector for introducing a coating to the material just before it enters the fragmentation zone. A shield is provided above the coating injection apparatus so that the coating injection apparatus is protected from material being ground in the fragmentation zone and material above the floor that is being transferred to the fragmentation zone.

### CROSS REFERENCE TO RELATED APPLICATIONS

None

### FIELD OF THE INVENTION

The present invention relates generally to tub grinders with systems to apply a colorant to the materials being processed. It more specifically relates to a system to apply the colorant material at the bottom of a tub, in close proximity to the grinding drum.

### DESCRIPTION OF RELATED ART

Ground-up organic materials are often colored, for example to improve their aesthetic value for landscaping applications, by the addition of a colorant during the grinding operation. This is usually done during a separate mixing operation conducted for the sole purpose of adding the colorant to manufacture a finished product. A consistent application of the colorant is required, to assure acceptable appearance of the product. Additives other than colorants may also be applied to various materials to improve or modify their characteristics.

A system capable of applying colorant, and other types of materials that are useful in modifying the characteristics of the ground material, is described in U.S. Pat. No. 6,207,228 to Hundt et al. This disclosure illustrates a type of machine commonly known as a horizontal grinder, which includes a rotor, and a feed system that moves material to the side/bottom of the rotor to be ground. Horizontal grinders include a fragmentation zone defined as being located adjacent and above this rotor. The space above the rotor, and in the fragmentation zone, is described as being an ideal location for injection of the colorant, or coating material.

Other types of grinders, known as tub grinders also include rotors to grind materials, forcing it through a screen similar to that described in the above mentioned reference; an example disclosed in U.S. Pat. No. 6,412,715 to Brand et al., which is incorporated herein in its entirety. However, with tub grinders the material is delivered to the rotor in different manner, and the rotor is located in a much different arrangement, with the screens in close proximity to the rotor. Thus there is no point in the fragmentation zone which lends itself to injection of coating materials.

Thus, in tub grinders, where coating materials are applied during the grinding operation, they are normally applied to the material as it is being initially fed into the machine, or applied to the material as it is being transported through the machine after being ground. If the coating material is applied prior to the grinding operation, it is difficult to control the amount applied, as some material will be coated excessively, while other material is not coated at all.

One possible system of applying the coating material after the grinding operation, but before the material is discharged from the machine, is illustrated in U.S. Pat. No. 6,412,530 to Mangold. This reference illustrates this system used in conjunction with a horizontal grinder. However, since the mixing operation is described as occurring in the material transfer portion of the machine, it is possible that this could alternately be utilized in a tub grinder. However, the length of the transfer portion required to assure proper coating, may not fit in the space normally available in a tub grinder. In addition, the capacity to transfer materials through this type of mechanism may not be sufficient to match the capacity of a tub grinder, thus there are possibly numerous technical problems associated with this arrangement, and often times the coating materials are simply applied to the material as it is transferred out of the tub grinders, without using this type of additional mixing apparatus. Both of these current methods thus have some difficulty associated with consistent coverage, and efficient use of the coating material.

Thus, there is a need for an improved system to apply coating material to materials being ground in a tub grinder.

### SUMMARY OF THE INVENTION

The present invention relates to an apparatus for grinding and concurrently applying coating materials to manufacture a coated product of a type including a substantially cylindrical tub for receiving material to be ground. The tub is operatively rotatably attached to a frame for causing material to be funneled towards an aperture in a bottom operatively rigidly attached to the frame. The bottom is disposed below the tub for forming a container with the tub. At least one curved screen is operatively attached to the frame below the aperture in the bottom. The curved screen is disposed about an axis of curvature and the curved screen has openings therein. A cylindrical grinding drum is operatively rotatably attached to the frame about a drum axis that is coincident with the axis of curvature of the curved screen. The cylindrical drum has an exterior periphery of the drum with teeth operatively attached to the exterior periphery of the drum. The teeth are adjacent to the curved screen whereby when the drum rotates material is ground between the screen and exterior periphery of the drum by the teeth. This arrangement forces material between the exterior of the drum and the curved screen to be ground into pieces that are small enough to pass through the openings in the screen. Thus a material fragmentation zone is formed below the aperture in the bottom of the tub, above curved screen and between the exterior periphery of the grinding drum and the curved screen.

A material deflector is operatively rigidly attached to the floor and is disposed over a portion of the aperture in the bottom of the tub thereby separating the material fragmentation zone from the material above the floor. A coating injection apparatus provided above the material deflector for introducing a coating to the material just before it enters the fragmentation zone. A shield is provided above the coating injection apparatus so that the coating injection apparatus is protected from material being ground in the fragmentation zone and material above the floor that is being transferred to the fragmentation zone.

### BRIEF DESCRIPTION OF THE DRAWINGS

The present invention will be more fully understood from the detailed description below when viewed in conjunction with the accompanying drawings in which:

FIG. 1 is a perspective view from one top angle of a tub grinder having the present invention thereon, a portion of the tub being cut away to show the placement of the present invention just above an aperture in the floor of the tub grinder;

FIG. 2 is a cross sectional view of the rotating tub, stationary floor, screen and rotating drum of a conventional tub grinder shown with a material deflector just above a fragmentation zone and above one of the screens to one side of the drum;

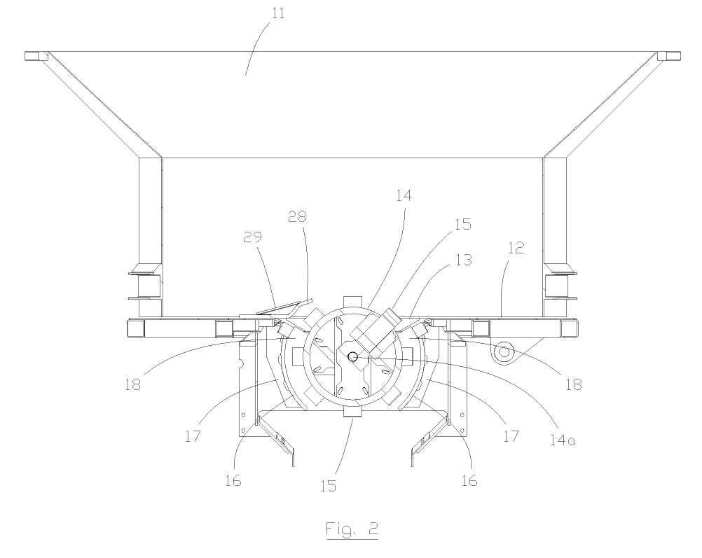

FIG. 3 is a cross sectional view, like FIG. 2, but showing the present invention attached thereto for introducing a fluid substance, such as a colorant, to the material to be ground, just above the floor of the tub grinder;

FIG. 4 is a perspective view from another a top angle showing a tub grinder with the present invention attached thereto;

FIG. 5 is a top view of a shield disposed above a material deflector and above a fluid injection outlet for protecting the fluid injection outlet from coming in contact with material being feed into a fragmentation zone below the floor of the tub grinder;

FIG. 6 is a cross sectional view taken along line 6-6 of FIG. 5 and showing the material deflector above the aperture in the floor of the tub grinder, a shield above the material deflector and a nozzle and fluid conduit leading to the nozzle, whereby the material deflector and the shield protect the conduit and nozzle from contact with the material in the tub and material in the fragmentation zone; and

FIG. 7 is a partially exploded perspective view of selected parts of the tub grinder of FIG. 2 before the apparatus of FIGS. 5 and 6 are connected thereto thereby showing a top view of the material deflector just above the fragmentation zone of the tub grinder.

### DETAILED DESCRIPTION OF THE INVENTION

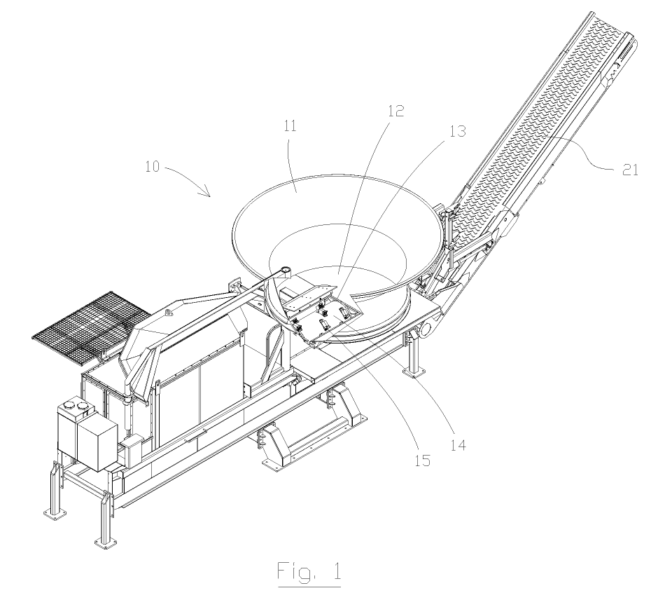

Referring now to the drawings wherein like reference numerals designate identical or corresponding parts throughout the several views, FIG. 1 shows an apparatus 10 constructed in accordance with a preferred embodiment of the present invention, having a tub 11 rotatably attached to a frame of the tub grinder above a floor 12. The floor 12 has an aperture 13 therein.

Below the floor 12 is a cylindrical drum 14 rotatable about a drum axis 14a. The drum 14 has teeth 15 extending from the external surface thereof. Screens 16 have openings therein of a predetermined size. The screens 16 are removably attached to supports 17 so that if a screen having larger or smaller openings therein as desired, such a replacement screen can be used. The size of the openings in the screens 16 determines the largest size of the particles of material that exit the tub grinder after the grinding process is complete. The screens are curved and are formed in an arc about the axis 14a, so that the teeth 15 can pass a predetermined distance from the screens 16, at least prior to any wear on the teeth 15.

A fragmentation zone 18 is formed below the floor 12. The fragmentation zone 18 is bounded by the aperture 13, which forms an inlet to the fragmentation zone 18. The screens 16 form another boundary of the fragmentation zone 18. When material, for example a tree limb enters the tub 11, it is rotated until it eventually comes in contact with the teeth 15 of the drum 14, at which time it is pulled into the fragmentation zone 18, where it is ground to pieces small enough to pass through the openings in the screen 16, at which time it is delivered to a conveyor belt 21 so it can be placed in a pile, on a truck or other place to be stored or transported.

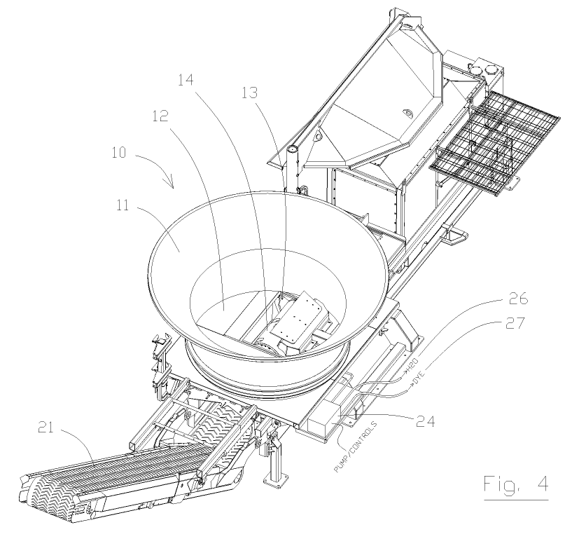

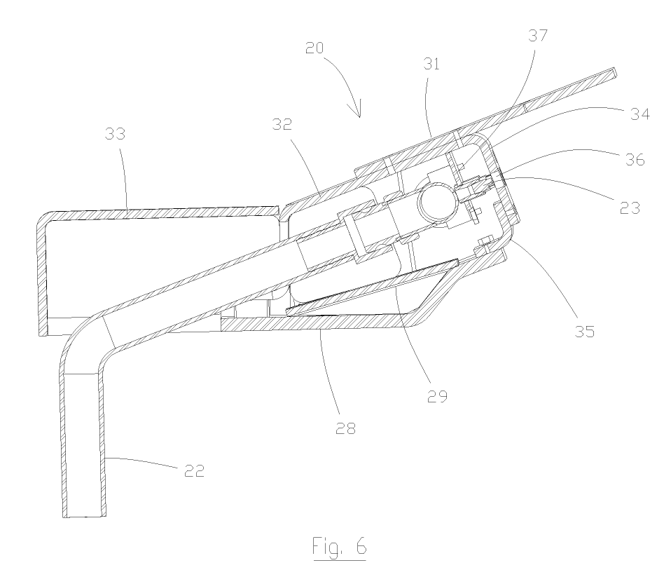

Referring now to FIG. 6, a coating injection apparatus 20 has a conduit 22 in fluid communication with a nozzle 23. Referring to FIG. 4, pump and pump controls 24 have a water inlet 26 and a liquid dye inlet 27. Not shown is the rest of conduit 22 that leads to the outlet of the pump controlled by pump and pump controls 24, all of this structure is conventional but which can be like that shown in U.S. Pat. No. 6,207,228 or 6,412,530, both such patents being incorporated herein by reference.

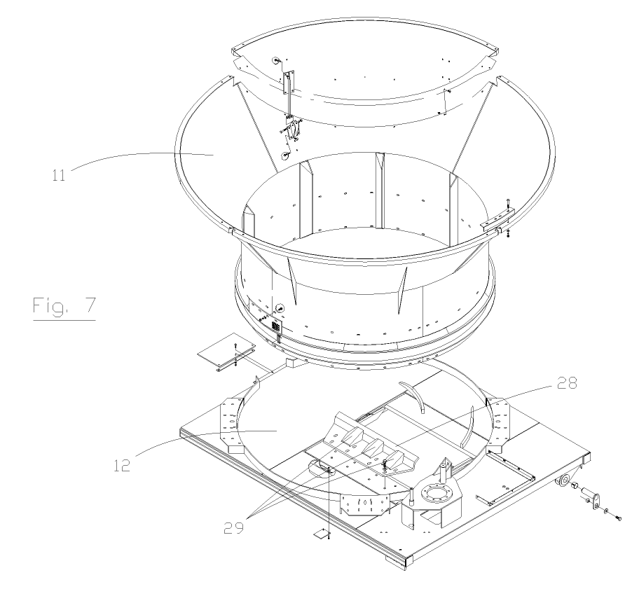

Referring again to FIG. 6, and to FIG. 7, a material deflector 28 having brace members 29 thereon, is rigidly attached to the floor 12 and defines a top boundary of the fragmentation zone 18. This material deflector 28 prevents material in the fragmentation zone 18 from damaging the nozzle 23 and/or the conduit parts 22 connected thereto.

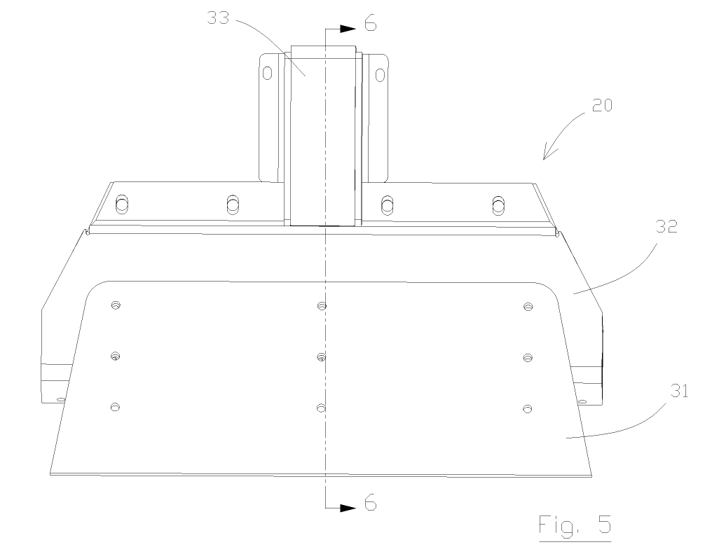

Referring to FIGS. 5 and 6, a shield formed of metal parts 31, 32, 33, 34 and 35 “shield” the nozzle 23 from material in the tub 11 of the tub grinder apparatus 10. The members 31, 32, 33, 34 and 35 can be connected together by any conventional method such as bolting, riveting or welding. An opening 36 in shield member 34 allows the nozzle to spray a fluid 40 outwardly into a space above the fragmentation zone 18. Bracket 37, attached to member 31 holds the nozzle 23 in place.

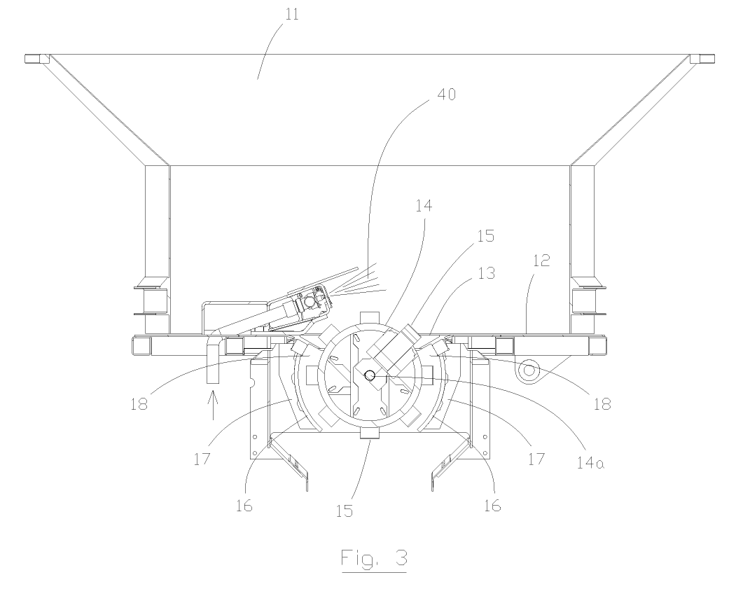

In operation, the tub grinder 10 is used in a normal fashion to grind whatever is placed in the tub 11. At the same time the pump controls 24 mix the water from water line 26 and a dye from dye line 27 together and pressurize the mixture and deliver it, through conduit 22, to nozzle 23 to spray the mixture 40 as shown in FIG. 3 to a place above the fragmentation zone 18. So the material there gets thoroughly coated with such mixture just before it is pulled into the fragmentation zone 18. This causes an optimum mixture of dye to be applied at an optimum time in the process.

Accordingly, it will be appreciated that the preferred embodiments do indeed overcome the deficiencies of the prior art explained above. Obviously many modifications and variations of the present invention are possible in light of the above teachings. It is therefore to be understood that, within the scope of the appended claims, the invention may be practiced otherwise than as specifically described.

1. Apparatus for grinding and concurrently applying coating materials to manufacture a coated product comprising:
a frame;
a substantially cylindrical tub operatively rotatably attached to the frame for receiving material to be ground;
a bottom operatively rigidly attached to the frame, the bottom being disposed below the tub for forming a container with the tub, the bottom having an aperture therein;
at least one curved screen operatively attached to the frame below the aperture, the curved screen being disposed about an axis of curvature, the curved screen having openings therein;
a cylindrical grinding drum operatively rotatably attached to the frame about a drum axis that is coincident with the axis of curvature of the curved screen, the cylindrical drum having an exterior periphery of the drum;
teeth operatively attached to the drum adjacent the exterior periphery, said teeth being adjacent the curved screen whereby when the drum rotates material is ground between the screen and exterior periphery of the drum by the teeth and passes through the openings in the screen, a material fragmentation zone thereby being formed below the aperture in the bottom of the tub, above curved screen and between the exterior periphery of the grinding drum and the curved screen;
a material deflector operatively rigidly attached to the floor and disposed over a portion of the aperture in the bottom of the tub thereby separating the material fragmentation zone from the material above the floor; and
a coating injection apparatus located above the material deflector for introducing a coating to the material just before it enters the fragmentation zone.

2. The apparatus of claim 1 wherein a shield is disposed above the coating injection apparatus for protecting the coating injection apparatus from material moving in the tub above the floor.

3. The apparatus of claim 2 wherein the coating injection apparatus included a nozzle for spraying a coating to an area just above the aperture, and wherein the nozzle of the injection apparatus is disposed entirely between the material deflector and the shield.

4. The apparatus of claim 1 wherein the coating is a substance for adding color to the material that is ground.
